(19) United States
(12) Patent Application Publication
(10) Pub. No.: US 2010/0063775 A1
(43) Pub. Date: Mar. 11, 2010

(54) METHOD AND APPARATUS FOR TESTING AUTOMOTIVE COMPONENTS

(75) Inventor: John A. Colling, Livonia, MI (US)

Correspondence Address: HUSCH BLACKWELL SANDERS LLP, 190 Carondelet Plaza, Suite 600, ST. LOUIS, MO, 63105, US

(73) Assignee: ASSEMBLY & TEST WORLDWIDE, INC., Dayton, OH (US)

(21) Appl. No.: 12/208,503

(22) Filed: Sep. 11, 2008

(51) Int. Cl. G06F 15/00

(52) U.S. Cl. 702/182; 702/189

(57) ABSTRACT

Method and apparatus are provided for automatically testing automotive components for one or more operating parameters. At least one operating parameter dependent variable is sensed and the data collected regarding the values of the operating parameter are transmitted to a data processing system. The data processing system compares the measured data to pre-programmed operating data that will determine a pass/fail decision for the machine element. The dependent variable data are compared to a predetermined set of values as determined by a pass envelope defined between a set of maximum values and a set of minimum values which can be illustrated as curves for an operating cycle of the machine element. The data processing system can determine, as correlated to an independent variable, whether or not the values are acceptable for the dependent variable.

### BACKGROUND OF INVENTION

The testing of machines such as internal combustion engines having various operational elements or components has long been practiced. Typically, cold testing engines and its various machine elements is done using a test stand with the driving of the machine for testing being accomplished by an electric motor. For internal combustion engines, this is referred to as a cold test, the engine is not running or combusting fuel. The tests are conducted to determine the quality of various machine elements prior to the machine being distributed for use. This can be done, for example, with high value engines or engines requiring a high level of confidence that the engine will not fail. Such engines can include diesel engines used in trucks and other conveyance devices, generators and the like. An engine will be tested to determine the condition or quality of many component parts or systems. Intake and exhaust manifold pressures, engine friction, turbochargers, fuel delivery systems, engine compression and the like may be tested. An operating parameter (dependent variable) measured during the test is normally correlated to some engine variable (independent variable), for example, the degree of rotation of the crankshaft, angular velocity (RPM) or time of operation. Testing currently involves the measurement of numerous data points and comparing each of the measured data points to a standard, for example, a waveform, calculating the permissible maximum and minimum value for a data point (e.g. ±3 sigma from the standard at a given value of an independent variable) and determining if the measured data point is within the calculated permissible limits. The evaluation of some data points to determine if the component is operating within specification has often been complex, for example, reviewing the value, slope of the operating curve, etc. and calculating the tolerance limits for each measured data point. This method is time consuming and expensive particularly when numerous operating parameters are being measured and numerous values for each operating parameter are evaluated for compliance with standards. Engine tests can involve as many as 3000 calculations. This method also limits the amount of data that can be analyzed given the expense and time constraints needed to perform the job. Such a method also provides little information on the cause of the problem and perhaps how to repair the problem to place the engine, or other machine element, into specification.

Thus, there is a need for an improved method and apparatus for testing machine elements to improve the efficiency of the testing and the value of the data gathered.

### SUMMARY OF INVENTION

The present invention involves the provision of a method of testing a machine. The method includes operating a machine and its elements (component parts) to be evaluated. A first operating parameter (dependent variable) of the machine element is sensed during the operation. An output signal is provided indicative of a value of the first parameter relative to an independent variable. The first output signal is processed and recorded as a function of the independent variable. A tolerance value envelope for the first parameter is provided as a function of the independent variable for a predetermined test period or cycle. It is then determined if the values of the first dependent variable fits within the value envelope over the test cycle. The machine element can then be evaluated as to whether or not it operates within specification.

The present invention also involves the provision of an apparatus for testing a machine such as an automotive component, e.g., an engine, transmission and a differential axle. The apparatus includes a drive device operable for operating at least a portion of the machine. A sensor is provided and is operable to sense a first operating parameter of a machine element and provide an output signal indicative of a value of the first parameter over time. A data collection system is provided and is operably connected to the sensor to receive the output signal therefrom. A data processing system is provided and is operably connected to the data collection system and is operable to associate the value of the operating parameter to an independent variable and then compare the value to predetermined upper and lower value limits in a stored value envelope at a predetermined value of the independent variable. An output device is also provided and is operably connected to the data processing system. The output device is operable to expose results of a comparison of the measured value of the operating parameter to the stored value envelope.

The apparatus and method of the present invention provides output sufficient for determining whether or not the machine element is within or outside specification.

### BRIEF DESCRIPTION OF DRAWINGS

FIG. 1 is a schematic illustration of a test apparatus useful for testing machine elements.

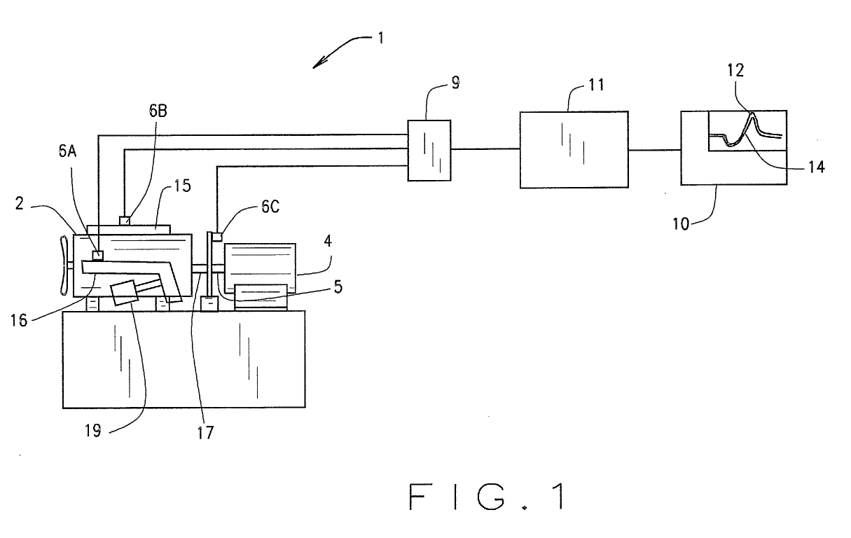

FIG. 2 is a flow diagram illustrating schematically, a process for testing machine elements.

FIG. 3 is an illustration of an output device showing a pair of waveforms defining a machine element specification envelope demonstrating a zone of values of an operating parameter as a function of an independent variable reflecting an acceptable part.

Like numbers throughout the various Figures designate like or similar parts and/or construction.

### DETAILED DESCRIPTION

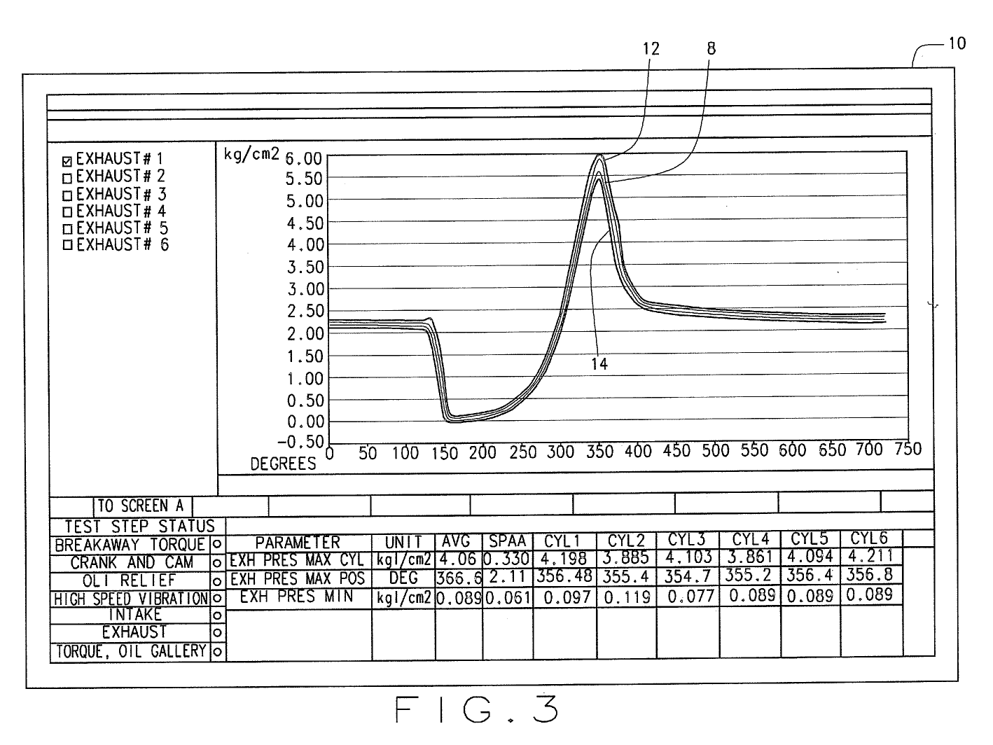

The reference numeral 1 designates generally an apparatus for testing a machine element 2 with various operational elements. The machine 2 (hereinafter referred to as an engine for convenience) can include such things as an internal combustion engine, automotive transmission (manual or automatic), automotive gear transfer cases and automotive axles having a rotatable component such as a differential axle. In the illustrated structure, an internal combustion engine 2 is shown. The engine 2 can be either a diesel or a gasoline powered engine. It could be a piston engine or a turbine-type engine. In the illustrated structure, the test apparatus 1 includes a drive device 4, which preferably provides a rotary output, with a shaft 5 to drive the engine 2. The drive device 4 can be an electric motor such as a variable speed rotary motor. The apparatus 1 also includes at least one sensor 6 and as illustrated, includes three sensors 6 denoted 6A, 6B, 6C for clarity. Any suitable number and type of sensors can be provided. The sensors 6 can include electric current, voltage, resistance, force, pressure and temperature sensors, angle encoders and angular velocity sensors. The apparatus includes a data collection system, designated generally 9 such as a multi-channel data collector, e.g., a model 6120 or 6170 available from National Instruments Corporation of Austin, Tex. The data collection system 9 is operably connected to the sensors 6 to receive signals therefrom and to provide an output to a data processing system designated generally 11. The data collection system 9 can be a card that can be coupled to a processor within the housing containing the data processing system 11. The data processing system 11 is operable to associate the values of dependent variables monitored by the sensors 6A, 6B and to compare the values gathered to a stored value envelope 8 (FIG. 3) reflecting a predetermined acceptance specification for a dependent variable as a function of an independent variable as defined by maximum and minimum curves 12, 14 respectively. The data processing system 11 associates some of the signals from certain of the sensors 6 to an independent variable which may be provided by, for example, sensor 6C which can be a rotation angle encoder or clock indicating time of operation. The apparatus 1 further includes an output device 10 operably connected to the data processing system 11 and is operable to expose the results of the comparison of the values of one or more dependent variables provided by the sensors 6A, 6B and data collection system 9 to the stored value envelope 8.

In the illustrated structure, the machine 2 is shown as an internal combustion engine. It includes an intake manifold 15, an exhaust manifold 16, a crankshaft 17 and a turbocharger 19. In the illustrated structure, and for illustrative purposes only, only two sensors 6A, 6B are shown as being associated with the engine 2. As shown, the sensor 6A is associated with the exhaust manifold 16 and the sensor 6B is associated with the intake manifold 15. Other sensors may be provided and provide values of such things as cylinder pressure, fuel system injection pressure, fuel system injection timing, glow plugs, relief (when the pressure relief valve opens) and gallery (low RPM oil pressure) oil pressure, exhaust manifold pressure, intake manifold pressure, cam timing sensor, crankshaft sensor, high/low ignition voltage, breaking (the torque required to initially start a machine turning) and running (the torque used to keep a machine turning) torque, oil FFT (FFT stands for Fast Fourier Transform) and orders, variable valve timing, vibration and FFT (Fast Fourier Transform of raw vibration transformation from a time domain to a frequency domain) and order. Transmissions may be tested for vibration and order, torque, gear ratio and gear mesh. Differential axles may be tested for vibration and order analysis, speed sensing in the spindles, torque, gear mesh and gear ratio. The illustrated sensor 6A could be used to measure exhaust manifold pressure, one for each cylinder, and the sensor 6B could be used to measure intake manifold pressure at one or more positions in the intake manifold 15. Such sensors are well known in the art.

The engine 2 is coupled in driven relationship to the drive device 4 as by connecting the output shaft 5 of the drive device 4 in a suitable manner to the crankshaft 17 of engine 2. The sensor 6C can be an angle position encoder and provide a signal such as angular position of rotation of either the drive device 4 and/or crankshaft 17. The sensor 6C could also provide an angular velocity signal if desired. The output of the sensor 6C provides an independent variable value to which the outputs of the sensor 6A, 6B are correlated for evaluation. Torque may also be measured with a sensor operably coupled to the shaft 5 or crankshaft 17 or can be provided with a measurement of the operating condition of the drive motor 4 for example with an ammeter. The outputs of the sensors 6 are provided to a data collection system 9. Input signals are received from the sensors 6. The received signals may be digitized and communicated to the data processing system 11 or digitized by the processing system 11. Data can be supplied while monitoring the sensors 6 simultaneously or individually or in groups at selected times of operation of the engine 2. For example, the cylinder pressure values for all cylinders may be gathered simultaneously and adjusted for the differences in angular position of each cylinder so all data points gathered will fit within a single value envelope 8.

The data processing system 1I can be any suitable computing device having a memory and a digital processor. For example, a PC (personal computer) can be utilized. The system 11 is operable to receive data from the data collection system 9 and analyze data in accordance with pre-programmed instructions. The system 11 will associate the dependent variable values of the measured operating parameter or parameters to at least one independent variable for example, rotational position of the crankshaft 17 of engine 2 and/or time. This independent variable value or values will be an abscissa value while the values of the operating parameters will be an ordinate value of a graph. The data processing system 11 includes information which defines an acceptable value or values for the operating parameters (dependent variables) as measured by the sensor 6A, 6B etc. This may be provided by either of algorithms or equations which will define envelope 8 boundaries 12, 14 defining a set of predetermined maximum and minimum values for the operating parameter as a function of the abscissa value (independent variable), for example, rotation angular position and/or time. Such values will be determined at a predetermined operating condition of the engine 2 as for example its angular velocity, temperature, etc. depending upon the need for ensuring an appropriate pass/fail criteria. In the case of an engine test, the engine is not running, i.e. a cold test, but is being driven by drive 2. It is to be understood that the present invention can be practiced on a running engine. The data gathered by the sensors 6 can be compared to predetermined limits by using at least two algorithms defining upper and lower value limits and/or look up table values to determine whether or not a measured value is within or outside a predetermined tolerance range for the operating parameter (dependent variable) at a given value for the abscissa (independent variable). When using look up tables defining the stored value envelope 8, interpolation of dependent variable values between stored values for the stored independent variable values may be performed.

At predetermined intervals of the value of the independent variable, the data processing system can determine the maximum/minimum values for an acceptable part either by calculation, by knowing the equation for the maximum/minimum values as a function of the independent variable over the test cycle of the independent variable, and determine whether or not the measured value falls within the envelope defined by the two waveforms 12, 14 or value traces as seen in FIG. 3. The measured values of an operating parameter of a machine element may also be compared to predetermined maximum and minimum values at one or more given values of an independent variable as stored in a look up table. The values in the look up table are predetermined and can represent points on the waveforms 12, 14 and define the envelope 8. The envelope 8 could also be defined as a display screen object and measured data points displayed on the screen and the data processing system 11 can determine if the measured data points are positioned inside or outside the defined object. Thus, the apparatus 1 can determine if a machine element, e.g., a piston and cylinder is operating in a specified compression pressure range over an operating cycle, say two engine revolutions. The data processing system can also plot the measured values of the operating parameter and an operator can visually review those values on a visual display output device 10 and visually determine if the dependent variable values fall within the acceptable range as defined by the envelope 8 throughout the test cycle. The data processing system can also be programmed to correlate various operating parameters to one another. For example, cylinder pressure can be correlated to intake and exhaust manifold pressure. This correlation can be used to determine possible causes of non-compliance of an operating parameter to specification. If, for example, cylinder pressure is low, the manifold pressures can be reviewed to determine if either is high to indicate the possibility of a bad valve/valve seat.

While a value for an operating parameter may change widely over time or crankshaft rotational position for some dependent variables, for example, cylinder pressure, some dependent variables will change little if any over time or other independent variable. One such operating parameter could be engine friction or oil pressure. Some operating parameters may be sensitive to the angular velocity of the engine 2 and thus, the output angular velocity of the drive device 4 should be controlled and set at a predetermined “standard” value. For dependent variables that change little, if any, through an operating cycle, the independent variable could be a standard constant such as angular velocity. The data processing system 11 can provide an output signal to the drive device to control its operation in accordance with preset standards and can be programmed to gather data in a desired sequence.

The output device 10 may be a display monitor, printer, plotter, either individually or in combination. If data is visually displayed, the output device 10 can also provide information to an operator as to whether or not the machine element being tested passes or fails the test. The possible cause of a failure as discussed above may be transferred with a machine to facilitate its repair or deficiency analysis. The machine 2 may be provided with a data storage device such as an encoded RFID chip or the like which in subsequent processing of the machine 2, for example, in a repair process, the machine 2 would maintain its identity during the repair process and a retesting process, which, according to predetermined criteria would not be retested for certain operating parameters that are not coupled to a failed operating parameter. For example, if an engine fails because of low oil pressure, there may be no need to retest cylinder pressure. This information can be stored and processed in the data processing system 11 to increase the automation of the testing procedure and reduce the need for human intervention and setting up, conducting or evaluating the test results.

The apparatus as described above is better understood by description of the process of testing an automotive component.

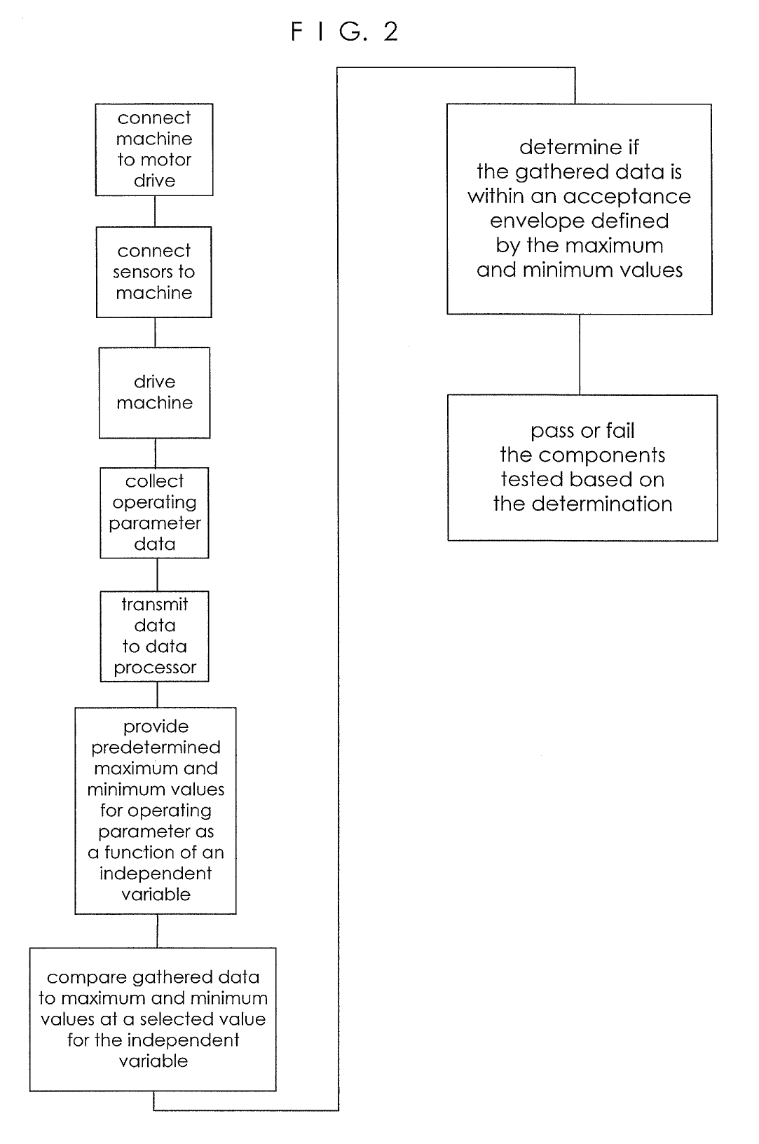

A simplified schematic of a testing procedure is illustrated in FIG. 2. A machine 2 which is to be tested is coupled to the drive device 4. In accordance with predetermined criteria, the drive device 4 upon command moves at least a portion or component of the automotive component at a predetermined operating speed or within a speed range. In the example of an engine, the crankshaft 17 can be rotated at a prescribed angular velocity and the independent variable, for example the degree of rotation of the crankshaft is provided as a signal from the sensor 6C to the data collection system 9. The data processing system 11, through the data collection system 9, will receive operating parameter input signals from sensors 6A, 6B in turn or in preselected groups. These operating parameter input signals are correlated to an appropriate independent variable and are compared to stored information maximum and minimum values defining an envelope 8 that can be represented by waveforms for an operating parameter. These values may be established by algorithms or tabulated in a look up table as a function of a selected independent variable or defined as a screen object. A standard for the values of a dependent variable can be established by studies of an operating parameter and appropriate statistical analysis. Further analysis, such as statistical analysis, will establish the upper and low limits of values of an operating parameter as a function of an independent variable. The upper and lower value limits can be determined by adding and subtracting values from the standard and thereby define the envelope 8 of acceptable values for the operating parameter. A preferred embodiment of the present invention involves adjusting the standard value by up to about ±3 sigma and preferably up to about ±2 sigma which value is determined by the quality need for the operating parameter and its associated machine component(s). The data processing system 11 can calculate whether or not at a given value of the independent variable, whether or not the dependent variable values are within an acceptable range of predetermined maximum and minimum values. For example, an engine can have its cylinder pressure analyzed for every one degree of rotation of two complete rotations of the engine. The lag time for the operation of a sensor 6 can also be programmed into the data processing system 11 or accommodated in a look up table, waveform or algorithm to make the test even more precise. The data processing system 11, through the comparison of the measured data to the programmed information, data points and/or algorithms, will determine whether or not the test is passed or failed. In the event that the test is passed for all measured dependent variables, the tested machine 2 can then be made ready for disposition for example, sale to a customer.

The data processing system 11 can be pre-programmed to provide a predetermined number of test points for evaluation and comparison which may vary by the measured operating parameter. Some parameters will have a large degree of change during one operating cycle for example, two revolutions of a four stroke engine to provide one complete operating cycle for that component. For example, cylinder pressure will vary widely as the engine passes through one complete test cycle while oil pressure or engine friction will have little if any change. The present invention is particularly adapted for testing the performance for operating parameters that vary widely during one complete test cycle. For variables that do not change much, the data processing system 11 can be programmed to work for a single data point but it is preferred that the data be gathered throughout at least one complete operating cycle for each variable. The operating parameters to be evaluated may be tested for individually, all at once or in preselected groups. In the event the machine element 2 fails on one or more tests, the machine 2 can then be encoded with an identifier such as an RFID tag and passed to a repair department. After repair, which may be indicated automatically by the encoded data, the machine element 2 may be then retested to determine whether it passes or fails.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of testing an automotive component, the method including:
moving a portion of an automotive component;
sensing a first operating parameter of the automotive component during said movement and providing a first output signal indicative of a value of the first parameter over time;
processing the first output signal and recording it as a function of an independent variable;
providing a value envelope having predetermined maximum and minimum values for the first parameter as a function of the independent variable; and
determining if the sensed first parameter value fits within the value envelope over a predetermined range of independent variable values.

2. The method of claim 1 wherein the moving including rotating at least a portion of the automotive component.

3. The method of claim 2 wherein the determining being at least partially by comparing the sensed first parameter value to the maximum and minimum values of the first parameter at a plurality of values of the independent variable.

4. The method of claim 3 wherein the machine element including an internal combustion engine and the first operating parameter including at least one of intake manifold pressure, exhaust manifold pressure, breaking torque, running torque, cylinder pressure, turbocharger pressure, oil pressure, fuel system pressure, ignition voltage, valve timing, vibration, glow plug operation, cam timing, variable valve timing and vibration.

5. The method of claim 4 wherein the independent variable including rotational position of a crankshaft of the engine.

6. The method of claim 4 wherein the comparing being performed at predetermined values of the independent variable.

7. The method of claim 4 wherein the envelope having first and second curves defining upper and lower boundaries of the envelope with the first and second curves being defined mathematically as a function of the independent variable and the comparison of a value of the first parameter to the boundaries of the envelope being performed at a plurality of given values of the independent variable.

8. The method of claim 7 wherein an engine being accepted or rejected based on the comparison of the value of the first parameter to the upper and lower envelope values at a predetermined value of the independent variable.

9. The method of claim 1 wherein the value envelope being defined by first and second algorithms.

10. The method of claim 1 wherein the value envelope being defined by a set of maximum values and a set of minimum values of the first parameter stored in a look up table.

11. The method of claim 1 wherein the value envelope being defined as a screen object.

12. The method of claim 4 including correlating the first parameter values to values of a second parameter if any first parameter value is outside the value envelope.

13. The method of claim 1 wherein the automotive component including at least one of an engine, transmission, transfer case and a differential axle.

14. An apparatus for testing an automotive component, the apparatus including:
a drive device;
at least one sensor operable to sense a first operating parameter of an automotive component and provide a first output signal indicative of a measured value of the first parameter over time;
a data collection system operably connected to the sensor and operable to receive the first output signal;
a data processing system operably connected to the data collection system and operable to correlate the measured value of the first parameter to an independent variable and compare the measured value of the first parameter to a stored value envelope providing predetermined maximum and minimum values for the first parameter as a function of the independent variable; and
an output device operably connected to the data processing system operable to expose results of a comparison of the measured value of the first parameter to the stored value envelope.

15. The apparatus of claim 14 wherein the drive device including a rotary motor.

16. The apparatus of claim 15 wherein the sensor including at least one of a current, voltage, resistance, sensor, force sensor, pressure sensor, angular velocity sensor, angle sensor, and a temperature sensor.

17. The apparatus of claim 16 including a second sensor operable to provide a signal indicative of an angle of rotation of an automotive component when coupled to the drive device.

18. The apparatus of claim 16 including an angular velocity sensor device operatively associated with the drive device.

19. The apparatus of claim 17 wherein the output device including a display monitor.

20. An apparatus for testing an internal combustion engine, the apparatus including:
a drive device;
at least one sensor operable to sense a first operating parameter of an internal combustion engine and provide a first output signal indicative of a measured value of the first parameter over time;
a data collection system operably connected to the sensor and operable to receive the first output signal;
a data processing system operably connected to the data collection system and operable to correlate the measured value of the first parameter to an independent variable and compare the measured value of the first parameter to a stored value envelope providing predetermined maximum and minimum values for the first parameter as a function of the independent variable; and
an output device operably connected to the data processing system operable to expose results of a comparison of the measured value of the first parameter to the stored value envelope.
